(19) United States
(12) Patent Application Publication
(10) Pub. No.: US 2007/0253589 A1
(43) Pub. Date: Nov. 1, 2007

(54) Earphone

(76) Inventors: Toon Jeow Foo, Taipei (TW); Steel Su, Taipei (TW); Shen Feng Huang, Taipei (TW)

Correspondence Address: BACON & THOMAS, PLLC, 625 SLATERS LANE, FOURTH FLOOR, ALEXANDRIA, VA, 22314, US

(21) Appl. No.: 11/410,909

(22) Filed: Apr. 26, 2006

(51) Int. Cl. H04R 25/00

(52) U.S. Cl. 381/384; 381/370

(57) ABSTRACT

The present invention relates to an earphone that comprises a speaker, a signal wire, housing, and a sound pressure adjustment mechanism. One end of the signal wire is electrically connected to the speaker. The housing holds the speaker and part of the signal wire; the other end of the signal wire extends outside the housing. The sound pressure adjustment mechanism is installed on the housing and provided with at least one hole; the hole is adjustable and/or may be completely closed.

### FIELD OF THE INVENTION

The present invention relates to earphones, and more particularly, to an earphone that can regulate the sound properties of the earphone for adapting to anyone while listening versatile musical tones.

### BACKGROUND OF THE INVENTION

In general, the earphone is used more and more frequently for people. A conventional earphone comprises housing, a speaker and a signal wire. The housing contains the speaker and part of the signal wire. Some through holes are installed on the housing body essentially in the proximity of the speaker, to allow sounds of speaker generated to be emitted outward via the through holes. The housing is sealed except for the through holes. Limited to the predetermined capacity of the sealed housing, the sound effect amplified by the conventional earphone speaker becomes almost invariable in pitch property.

In view of the drawbacks of the conventional earphone, an innovative earphone is provided to regulate the sound properties of the earphone for adapting to anyone when listens versatile musical tones.

### SUMMARY OF THE INVENTION

Accordingly, an object of the present invention is to provide an improved earphone to accommodate sound properties generated, such as high pitch and low pitch, to meet user criteria while listening versatile musical tones.

To achieve the above object, the present invention provides an improved earphone which comprises a speaker, a signal wire, housing, and a sound pressure adjustment mechanism. One end of the signal wire is electrically connected to the speaker. The speaker and part of the signal wire are fitted on the housing, whereas the other end of the signal wire extends outside the housing. The sound pressure adjustment mechanism is installed on the housing and equipped with at least one opening; the opening is reconfigured to adjust and/or completely closed.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawing, in which:

FIG. 1 is a cross-sectional view of an earphone according to the first embodiment of the present invention;

FIG. 2 is an exploded view in section of a sound pressure adjustment mechanism shown in FIG. 1;

FIG. 3 is a cross-sectional view of an earphone according to the second embodiment of the present invention;

FIG. 4 is an exploded view in section of a sound pressure adjustment mechanism shown in FIG. 3; and

FIG. 5 is a cross-sectional view of an earphone according to the third embodiment of the present invention.

### DETAILED DESCRIPTION OF THE INVENTION

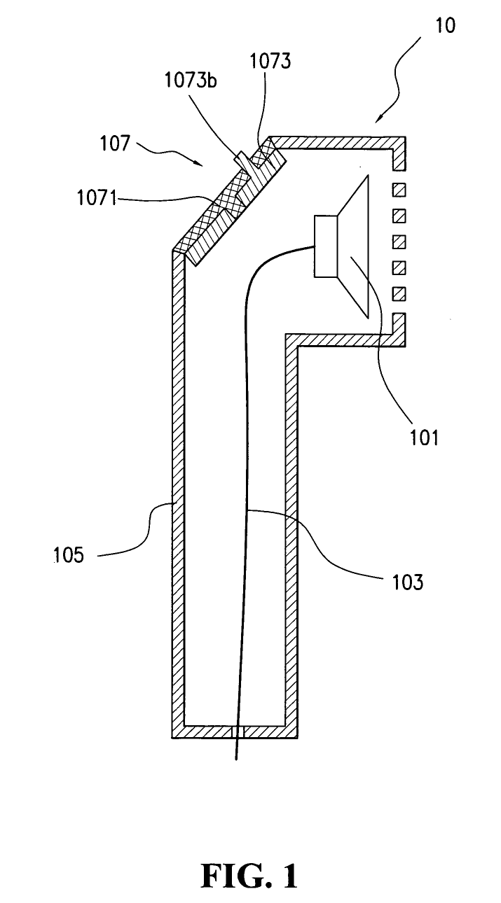

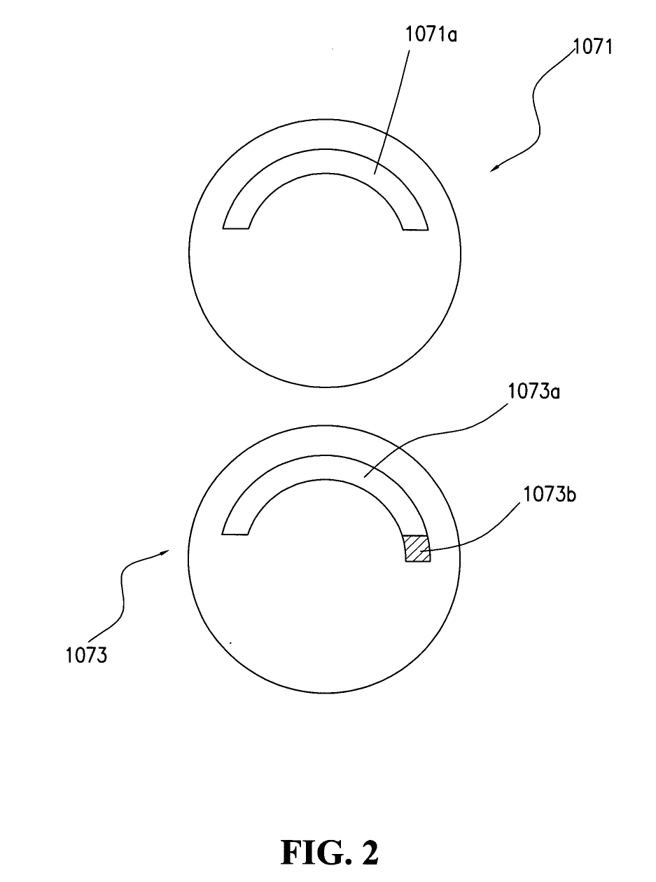

FIG. 1 is a cross-sectional view of an earphone according to the first embodiment of the present invention, whereas FIG. 2 is an exploded view in section of a sound pressure adjustment mechanism shown in FIG. 1. The earphone 10 of the present invention comprises a speaker 101, a signal wire 103, a housing 105, and a sound pressure adjustment mechanism 107, as described below respectively.

The speaker 101 and part of the signal wire 103 are fitted on the housing 105. One end of the signal wire 103 is electrically connected to the speaker 101. The other end of the signal wire 103 extends outside the housing 105. The speaker 101 converts the electrical signal transmitted by the signal wire 103 into sound, thereafter the sound is sent to outside the housing 105.

In the first embodiment, the sound pressure adjustment mechanism 107 comprises a fixation disk 1071 and a knob 1073. A first opening 1071a and a corresponding second opening 1073a are disposed in the fixation disk 1071 and the knob 1073 respectively. The fixation disk 1071 is installed on the housing 105, whereas the knob 1073 is installed inside the housing 105 and pivoted to the fixation disk 1071. A protruding rod 1073b of the knob 1073 protruded out and moved along the first opening 1071a, thereby rotates the knob 1073 around the center of the fixation disk 1071, to alter the way in which the first opening 1071a overlaps the second opening 1073a. Consequently, the opening of the sound pressure adjustment mechanism 107 could be adjustable or completely closed.

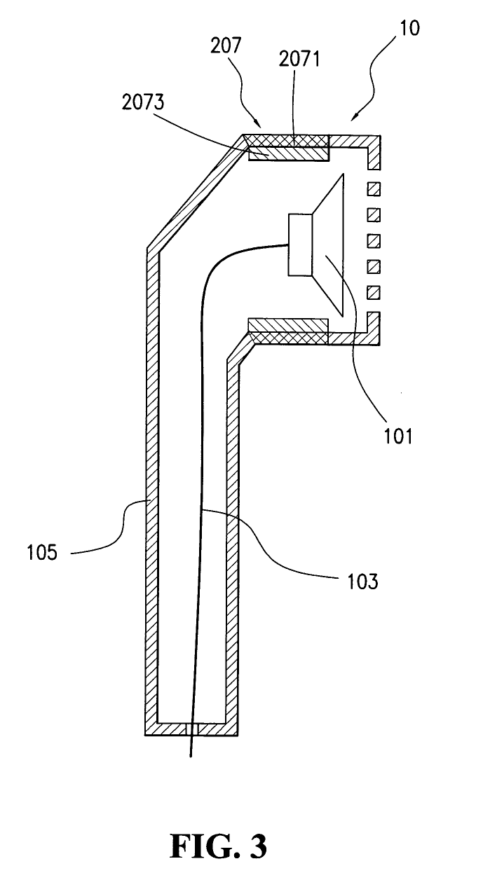

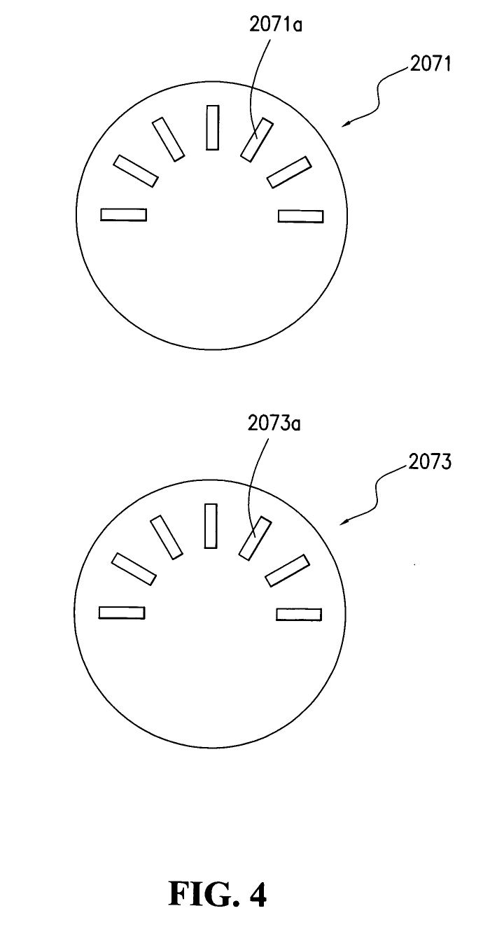

Further, with reference to FIGS. 3 and 4 to illustrate the second embodiment, FIG. 3 is a cross-sectional view of an earphone, whereas FIG. 4 is an exploded view in section of a sound pressure adjustment mechanism shown in FIG. 3. A sound pressure adjustment mechanism 207 comprises a knob 2071 and a fixation disk 2073. At least one first opening 2071a and at least one matching second opening 2073a are disposed in the knob 2071 and the fixation disk 2073 respectively. There may be a plurality of spaced apart first openings 2071a and a plurality of spaced apart second openings 2073a. The fixation disk 2073 is installed inside the housing 105, whereas the knob 2071 is installed on the housing 105 and put around the outer peripheral wall of the fixation disk 2073. The knob 2071 can be rotated in relation to the outer peripheral wall of the fixation disk 2073, thus varying the way in which the first openings 2071a overlap the second openings 2073a. As a result, the openings of the sound pressure adjustment mechanism 207 are adjustable or completely closed.

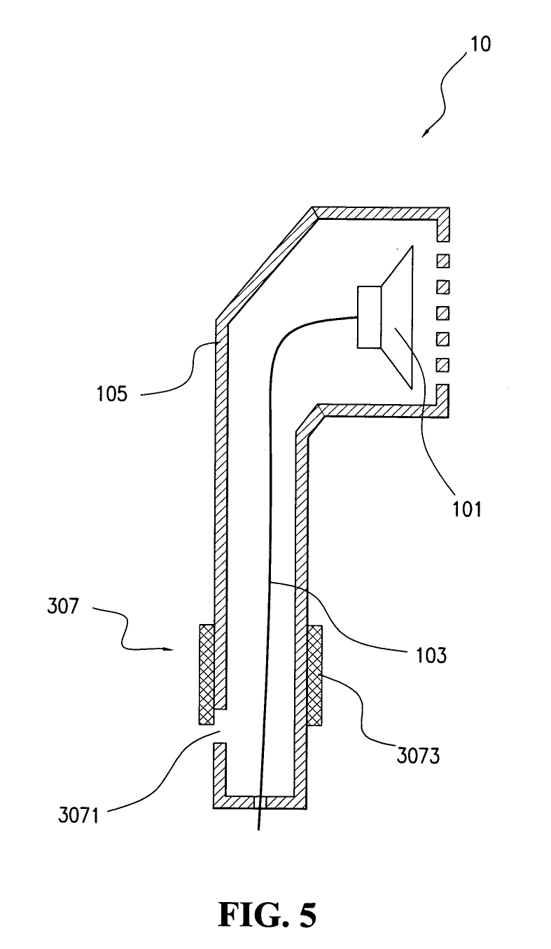

Referring to FIG. 5, FIG. 5 is a cross-sectional view of an earphone according to the third embodiment of the present invention. A sound pressure adjustment mechanism 307 of the third embodiment comprises a first opening 3071 and a knob 3073. The first opening 3071 is installed on the housing 105, whereas the knob 3073 is put around the outer peripheral wall of the housing 105. The knob 3073 can be rotated in relation to the outer peripheral wall of the housing 105, thus adjusting the first openings 3071. As a result, the opening of the sound pressure adjustment mechanism 307 is adjustable or completely closed.

To summarize, referring to FIGS. 1, 3, and 5, equipped with sound pressure adjustment mechanisms 107, 207, 307, an earphone 10 utilizes air flows generated inside the earphone 10 to be released via openings of the sound pressure adjustment mechanisms 107, 207, 307. The sound pressure adjustment mechanisms 107, 207, 307 are used to adjust the openings and vary sound properties, such as high pitch and low pitch while user listening versatile musical tones. In order to achieve the preceding objective, an earphone of the present invention has a function can regulate the sound properties of the earphone for adapting to anyone while listening versatile musical tones.

While the invention has been described by way of examples and in terms of preferred embodiments, it is to be understood that the invention is not limited thereto. To the contrary, it is intended to cover various modifications and similar arrangements and procedures, and the scope of the appended claims therefore should be according to the broadest interpretation so as to encompass all such modifications and similar arrangements and procedures.

What is claimed is:

1. An earphone, comprising:
a speaker;
a signal wire electrically connected to said speaker with one end;
a housing holding said speaker and part of said signal wire, wherein the other end of said signal wire extends outside said housing; and
a sound pressure adjustment mechanism disposed on said housing and having at least one opening, wherein said opening is adjustable and/or may be completely closed.

2. The earphone of claim 1, wherein said sound pressure adjustment mechanism comprising:
a fixation disk equipped with a first opening and installed on said housing; and
a knob equipped with a second opening, installed inside said housing, pivotally connected to said fixation disk, and being rotated around the center of said fixation disk, thus varying the way in which said first opening overlaps said second opening.

3. The earphone of claim 1, wherein said sound pressure adjustment mechanism comprising:
a fixation disk equipped with a second opening and installed inside said housing; and
a knob equipped with a first opening, installed on said housing and put around an outer peripheral wall of said fixation disk, wherein said knob can be rotated in relation to said outer peripheral wall of said fixation disk, thus varying the way in which said first opening overlaps said second opening.

4. The earphone of claim 1, wherein said sound pressure adjustment mechanism comprising:
a first opening disposed on said housing; and
a knob put around an outer peripheral wall of said housing, wherein said knob can be rotated in relation to said outer peripheral wall of said housing, thus adjusting said first opening.
